(19) United States
(12) Patent Application Publication
(10) Pub. No.: US 2021/0237367 A1
(43) Pub. Date: Aug. 5, 2021

(54) MANUFACTURING METHOD OF HIGH PRESSURE TANK

(71) Applicant: TOYOTA JIDOSHA KABUSHIKI KAISHA, Toyota-shi (JP)

(72) Inventor: Masayoshi TAKAMI, Hamamatsu-shi (JP)

(73) Assignee: TOYOTA JIDOSHA KABUSHIKI KAISHA, Toyota-shi (JP)

(21) Appl. No.: 17/143,434

(22) Filed: Jan. 7, 2021

(30) Foreign Application Priority Data
Jan. 31, 2020 (JP) 2020-014969

(51) Int. Cl. B29C 65/66; F17C 1/06

(52) U.S. Cl. CPC B29C 65/665; B29L 2031/7156; F17C 1/06

(57) ABSTRACT

A manufacturing method of a high pressure tank includes at least : shrinking a liner by cooling the liner, inserting the liner into a cylindrical member to cover a body of the liner in a shrunk state by the cylindrical member, expanding the liner in the shrunk state to fit the cylindrical member to the body by raising the temperature of the liner inserted into the cylindrical member, joining circumferential edge portions of dome members to circumferential edge portions of the cylindrical member that is fit to the body, to cover end portions by the dome members, and form a first reinforcing layer.

### CROSS-REFERENCE TO RELATED APPLICATION

This application claims priority to Japanese Patent Application No. 2020-014969 filed on Jan. 31, 2020, incorporated herein by reference in its entirety.

### BACKGROUND

### 1. Technical Field

The disclosure relates to a manufacturing method of a high pressure tank.

### 2. Description of Related Art

Natural gas vehicles, fuel cell vehicles, and so forth, for example, use high pressure tanks to store fuel gas. This type of high pressure tank has a liner for keeping the fuel gas in an airtight manner, which is covered by a reinforcing layer that is made of fiber reinforced resin.

Japanese Unexamined Patent Application Publication No. 2017-141947 (JP 2017-141947 A), for example, proposes a manufacturing method for such a high pressure tank. In this manufacturing method, first, a plurality of rounds of a fiber reinforced resin sheet are wound on a body of the liner by a sheet winding procedure, thereby forming a cylindrical portion on the body of the liner. Next, fiber bundles impregnated with resin are wound on the cylindrical portion and dome-shaped end portions of the liner by a filament winding procedure, thereby forming a reinforcing portion on the outer face of the liner, integrally with the cylindrical portion.

### SUMMARY

In the manufacturing method described in JP 2017-141947 A, the cylindrical portion is formed by winding a plurality of rounds of a single fiber reinforced resin sheet on the body of the liner, but overtightening may occur in the fiber reinforced resin sheet at the time of winding the fiber reinforced resin sheet directly onto the liner. This overtightening can lead to unexpected deformation of the liner.

The disclosure proposes a manufacturing method of a high pressure tank where a fiber reinforced resin sheet or the like is not wound onto the body of the liner when forming a reinforcing layer on the outer face of the liner, whereby unexpected deformation of the liner due to overtightening at the time of winding can be avoided.

A manufacturing method according to an aspect of the disclosure is a manufacturing method of a high pressure tank, where a reinforcing layer made of fiber reinforced resin is formed on an outer face of a liner that includes a body having a cylindrical shape and end portions having a domical shape and formed on both ends of the body. The method includes at least: preparing the liner, and a cylindrical member and two dome members that constitute the reinforcing layer, shrinking the liner by cooling the liner, inserting the liner into the cylindrical member to cover the body of the liner in a shrunk state by the cylindrical member, expanding the liner in the shrunk state to fit the cylindrical member to the body by raising a temperature of the liner inserted into the cylindrical member to a temperature prior to the cooling of the liner, and joining circumferential edge portions of the dome members to circumferential edge portions of the cylindrical member that is fit to the body, to cover the end portions of the liner by the dome members, and form the reinforcing layer.

According to the disclosure, the cylindrical member to cover the body of the liner, and the two dome members to cover the end portions of the liner are prepared in advance, and a reinforcing layer is formed from the cylindrical member and the two dome members. When forming the reinforcing layer, the liner is shrunk by cooling. This shrinking of the liner occurs in the radial direction of the body as well, and accordingly the liner can be easily inserted into the cylindrical member.

Thereafter, the temperature of the liner is raised to the temperature prior to cooling, thereby expanding the liner. Expansion of the liner occurs in the radial direction of the liner as well, and accordingly the cylindrical member can be fit to the body of the liner. Thus, the cylindrical member can be integrated with the body of the liner.

Due to the cylindrical member being integrated with the body of the liner in this way, the circumferential edge portions of the dome members can be easily joined to the circumferential edge portions of the cylindrical member, and the reinforcing layer composed of the cylindrical member and the two dome members can be easily formed on the outer face of the liner.

As described above, according to the disclosure, the reinforcing layer is formed on the outer face of the liner, rather than wrapping fiber reinforced resin sheets or the like on the body of the liner. Thus, only deformation taking into consideration the tightening margin between the body of the liner and the cylindrical member (calculated in advance) is generated in the liner by fitting the cylindrical member to the body, and accordingly unexpected deformation of the liner due to force of overtightening and so forth can be avoided. Note that when fitting the cylindrical member to the body, the temperature of the liner is raised to the temperature prior to cooling the liner, and while this raising of the temperature may be performed by heating, the temperature of the liner is preferably raised to where the temperature of the liner reaches the ambient temperature.

In the above aspect, the cylindrical member may be cylindrical. In the preparing of the liner and the cylindrical member and the two dome members, the liner and the cylindrical member may be prepared satisfying a dimensional relation where an outside diameter of the body of the liner is larger than an inside diameter of the cylindrical member. In the shrinking of the liner, the liner may be cooled to a temperature where the outside diameter of the body of the liner is smaller than the inside diameter of the cylindrical member. In the fitting of the cylindrical member to the body, the temperature of the liner may be raised to the temperature prior to the cooling of the liner, where the dimensional relation is satisfied. Note that the “temperature where the dimensional relation is satisfied” in this aspect is the temperature at the time of preparing the liner, the cylindrical member, and the two dome members, i.e., the temperature of the liner immediately prior to cooling the liner, which is the ambient temperature of the liner and cylindrical member.

According to this aspect, the body of the liner and the cylindrical member are cylindrical, and accordingly, when the temperature of the liner is raised to the temperature prior to cooling that satisfies the dimensional relation at the time of fitting the cylindrical member to the body, the outer circumferential face of the liner can be made to uniformly follow the inner circumferential face of the cylindrical member. Thus, gaps are not readily formed between the body of the liner and the cylindrical member.

In the above aspect, in the preparing of the liner and the cylindrical member and the two dome members, the outside diameter of the body and the inside diameter of the cylindrical member may be set such that a pressure of the cylindrical member pressing against the body of the liner after completion of raising the temperature of the liner is smaller than a yield stress of a material of the liner.

According to this aspect, after completion of raising of the temperature to fit the cylindrical member to the body, the pressure of the cylindrical member pressing against the body of the liner is smaller than the yield stress of the material of the liner, and accordingly the liner can be fit to the cylindrical member in a state where the liner is elastically deformed. Thus, the liner is not damaged by plastic deformation when fitting the cylindrical member to the body.

In the above aspect, the liner may be made of thermoplastic resin. According to this aspect, the liner is made of a thermoplastic resin material that is more ductile than metal, and accordingly even when there is plastic deformation of the liner in the process of fitting the cylindrical member to the body, cracks or the like do not readily occur in the liner. Due to being made of thermoplastic resin, the liner more readily follows the reinforcing layer when the liner is filled with high pressure gas. Further, even when there is plastic deformation, the liner readily exhibits creep deformation, and accordingly damage of the liner can be prevented.

According to the manufacturing method of a high pressure tank according to the disclosure, a fiber reinforced resin sheet or the like is not wound onto the body of the liner when forming a reinforcing layer on the outer face of the liner, whereby unexpected deformation of the liner due to overtightening at the time of winding can be avoided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a structure of a high pressure tank manufactured by a manufacturing method according to an embodiment of the disclosure;

FIG. 2 is a partial cross-sectional view illustrating the structure of the high pressure tank illustrated in FIG. 1;

FIG. 3 is a flowchart for describing processes of the manufacturing method of the high pressure tank according to the embodiment of the disclosure;

FIG. 4 is a partial cross-sectional view for describing a formation method of a dome member that is prepared in a preparing process illustrated in FIG. 3;

FIG. 5 is a cross-sectional view of the dome member that is prepared in the preparing process illustrated in FIG. 3;

FIG. 6 is a cross-sectional view for describing a forming method of a cylindrical member that is prepared in the preparing process illustrated in FIG. 3;

FIG. 7 is a cross-sectional view of a liner that is prepared in the preparing process illustrated in FIG. 3;

FIG. 8 is a schematic perspective view for describing a shrinking process and an inserting process in the manufacturing method illustrated in FIG. 3;

FIG. 9 is a schematic perspective view for describing a fitting process in the manufacturing method illustrated in FIG. 3;

FIG. 10 is a schematic cross-sectional view of the liner and the cylindrical member after the fitting process illustrated in FIG. 9;

FIG. 11 is a schematic perspective view for describing a joining process illustrated in FIG. 3; and

FIG. 12 is a schematic cross-sectional view of the liner and a reinforcing layer after the joining process illustrated in FIG. 11.

### DETAILED DESCRIPTION OF EMBODIMENTS

A manufacturing method of a high pressure tank 1 according to an embodiment of the disclosure will be described below with reference to the drawings. Prior to description of the manufacturing method, a configuration of the high pressure tank 1 will be described in brief. Although description will be made below that the high pressure tank 1 is a tank that is filled with high pressure hydrogen gas and that is installed in a fuel cell vehicle, the high pressure tank 1 may be applied to other usages as well. The gas that the high pressure tank 1 can be filled with is not limited to high pressure hydrogen gas, and may be filled with other gasses, such as various types of compressed gas such as compressed natural gas (CNG) and so forth, various types of liquified gas such as liquified natural gas (LNG) and liquified petroleum gas (LPG), and so forth.

### 1. High Pressure Tank 1

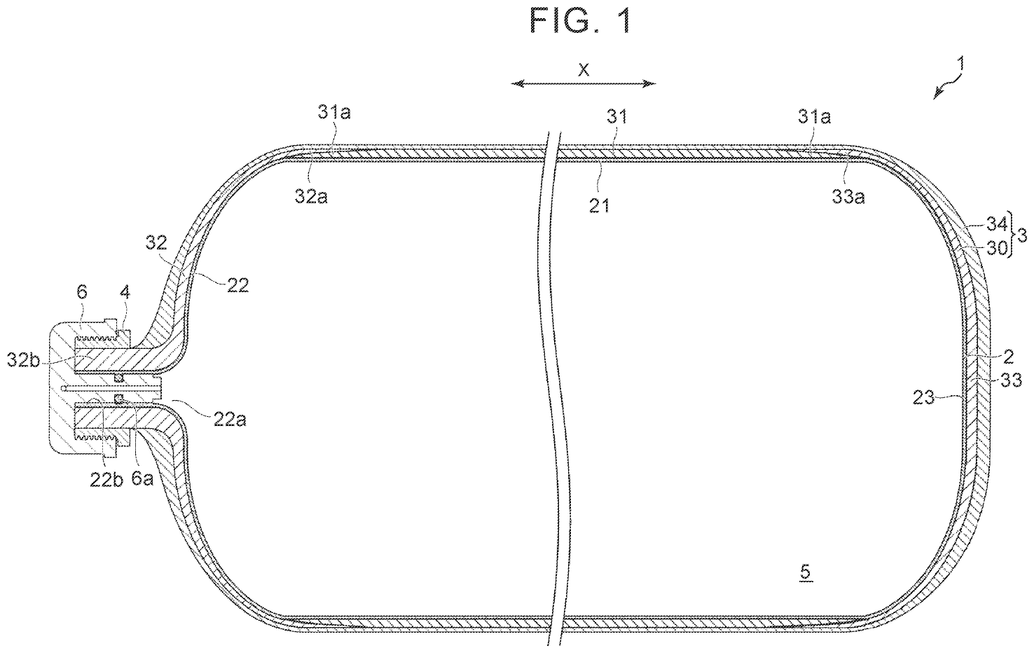

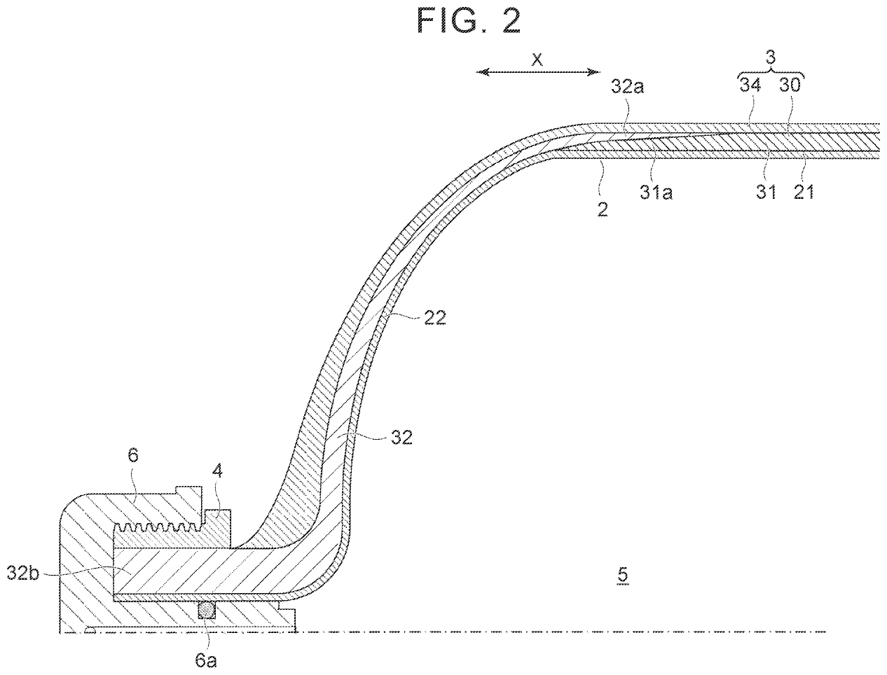

The high pressure tank 1 is a generally cylindrically-shaped high-pressure gas storage container, of which both ends are rounded in the form of domes, as illustrated in FIGS. 1 and 2. The high pressure tank 1 is provided with a liner 2 that has gas barrier properties, and a reinforcing portion 3 made of a fiber reinforced resin covering the outer face of the liner 2. The reinforcing portion 3 has a first reinforcing layer 30 that covers the outer face of the liner 2, and a second reinforcing layer 34 that covers the outer face of the first reinforcing layer 30. An opening is formed at one end of the high pressure tank 1, and a neck 4 is attached to the perimeter of the opening. Note that the first reinforcing layer 30 corresponds to the “reinforcing layer” in the disclosure.

The liner 2 is a resin member that constitutes an accommodation space 5 that is filled with high pressure hydrogen gas. The liner 2 is provided with a cylindrical body 21, and dome-shaped end portions 22, 23 provided on respective ends of the body 21. The body 21 extends for a predetermined length in an axial direction X of the high pressure tank 1 in the present embodiment, and is cylindrical in shape. The end portions 22, 23 are provided as continuations from respective ends of the body 21 and have dome-like shapes. The radii of the end portions 22, 23 decrease the farther away from the body 21, with an opening 22a provided at the center of the portion of the end portion 22 where the radius is the smallest. A tubular portion 22b is provided in the opening 22a.

The material of the liner 2 preferably is a resin or metal that has capabilities of holding high pressure gas filled in the accommodation space 5, i.e., good gas barrier properties. Examples of resin include polypropylene resins, nylon resins (e.g., nylon 6 resin, nylon 6,6 resin) polycarbonate resins, acrylic resins, acrylonitrile butadiene styrene (ABS) resins, polyamide resins, polyethylene resins, ethylene vinyl alcohol copolymer resin (EVOH), polyester resins, and like thermoplastic resins. Examples of metal include aluminum alloy and stainless steel.

The neck 4 is made of a metal material, such as aluminum and aluminum alloy, that has been worked to a predetermined shape. A valve 6 for filling hydrogen gas in the accommodation space 5, and discharging the hydrogen gas therefrom, is attached to the neck 4. A sealing member 6a that comes into contact with the tubular portion 22b of the liner 2, and seals off the accommodation space 5 of the high pressure tank 1, is provided to the valve 6, at a protruding portion 32b of the dome member 32, which will be described later.

The reinforcing portion 3 functions to improve the mechanical strength of the high pressure tank 1, such as rigidity, pressure-withstanding characteristics, and so forth, by reinforcing the liner 2. The reinforcing portion 3 is made of a fiber reinforced resin where reinforcing fibers (continuous filaments) are impregnated with resin. In the present embodiment, the reinforcing portion 3 has the first reinforcing layer 30 covering the outer face of the liner 2, and the second reinforcing layer 34 covering the outer face of the first reinforcing layer 30, as described above. The first reinforcing layer 30 is integrally formed of a later-described cylindrical member 31, and dome members 32, 33 joined to respective ends thereof

The cylindrical member 31 and the dome members 32, 33 are members where a plurality of layers of fiber reinforced resin of reinforcing fiber impregnated with resin are laminated. The reinforcing fibers of the cylindrical member 31 are oriented circumferentially at an angle generally orthogonal to the axial direction X of the cylindrical member 31. In other words, the reinforcing fibers of the cylindrical member 31 are oriented in the circumferential direction of the cylindrical member 31. The reinforcing fibers of the dome members 32, 33 are not oriented in the circumferential direction of the cylindrical member 31, but rather extend from around the apex toward circumferential edge portions 32a, 33a thereof, in various directions intersecting the circumferential direction.

The reinforcing fibers of the cylindrical member 31 and the reinforcing fibers of the dome members 32, 33 are not continuous (not connected) in the present embodiment. The reason is that the two dome members 32, 33 are attached to respective ends of the cylindrical member 31 after the cylindrical member 31 and the two dome members 32, 33 are separately formed, which will be described later.

The second reinforcing layer 34 is a layer where a layer of fiber reinforced resin made of reinforcing fiber impregnated with resin is laminated. The second reinforcing layer 34 is provided covering the outer face of the first reinforcing layer 30. That is to say, the second reinforcing layer 34 is a layer covering the outer face of the cylindrical member 31 and the dome members 32, 33. Specifically, the second reinforcing layer 34 is a layer made of fiber reinforced resin of which the fibers are oriented extending from one of the two dome members 32, 33 to the other. The reinforcing fibers of the second reinforcing layer 34 are oriented to be inclined as to the axial direction X of the cylindrical member 31 by helical winding of fiber bundles impregnated with resin. The reinforcing fibers allow the dome members 32, 33 to be constrained to the cylindrical member 31.

### 2. Manufacturing Method of High Pressure Tank 1

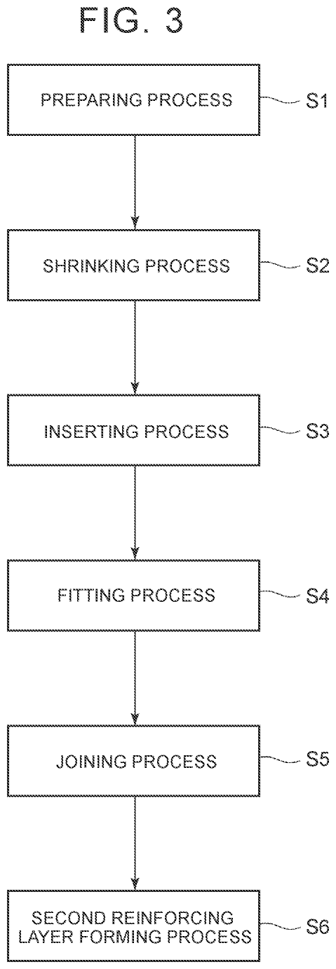

Next, a manufacturing method of the high pressure tank 1 according to the embodiment of the disclosure will be described. FIG. 3 is a flowchart for describing processes of the manufacturing method of the high pressure tank 1. The manufacturing method of the high pressure tank 1 includes a preparing process 51, a shrinking process S2, an inserting process S3, a fitting process S4, a joining process S5, and a second reinforcing layer forming process S6, as illustrated in FIG. 3.

### 2-1. Preparing Process 51

In the preparing process S1, the liner 2, and the cylindrical member 31 and the two dome members 32, 33 that constitute the first reinforcing layer 30, are prepared. Note that the liner 2 and the cylindrical member 31 that satisfy a dimensional relation of an outside diameter D1 of the body 21 of the liner 2 being larger than an inside diameter D2 of the cylindrical member 31 are prepared in the preparing process S1, which will be described later. First, method of forming the two dome members 32, 33 to be prepared will be described below.

### Method of Forming Dome Members 32, 33

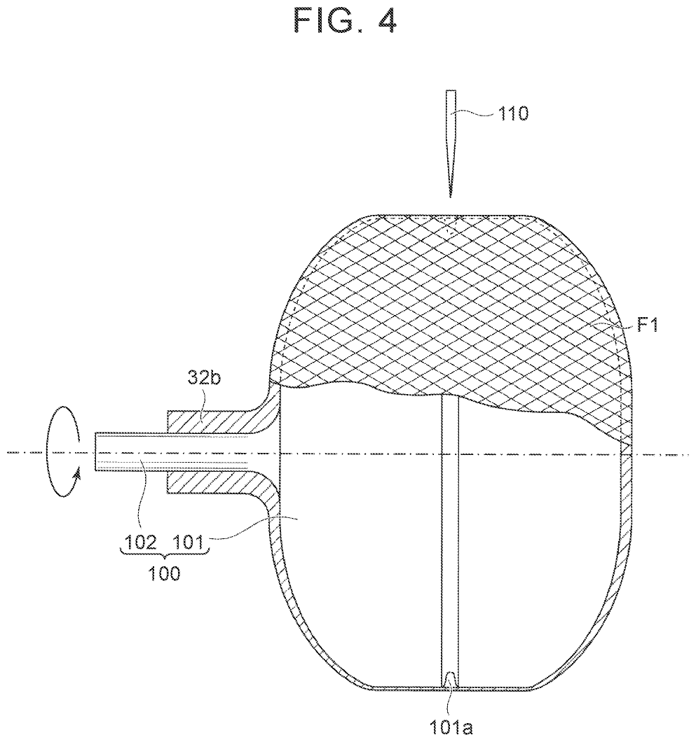

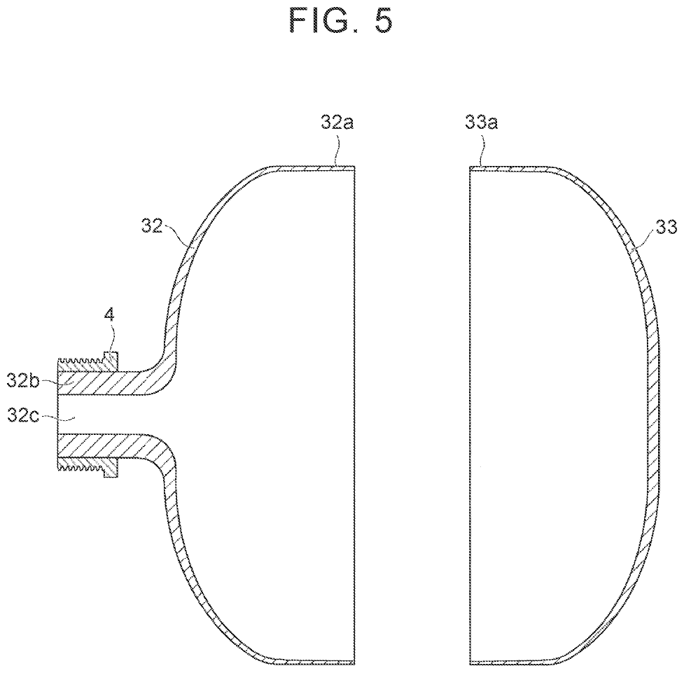

In the method of forming the dome members 32, 33 illustrated in FIG. 5, fiber bundle F1 impregnated with resin is wound onto an outer face of a mandrel 100 by a filament winding procedure (FW procedure), for example, as illustrated in FIG. 4. Specifically, the mandrel 100 has a main unit 101 and a shaft portion 102 that extends to the outer side from one end of the main unit 101.

The main unit 101 is formed having a circular shape as viewed from the axial direction of the shaft portion 102. A groove portion 101a is provided on the outer circumferential face of the main unit 101 at the middle in the axial direction, extending over the entire circumference in the circumferential direction. The outer face of the mandrel 100 has a shape where the dome-shaped end portions 22, 23 are connected without the body 21 of the liner 2 prepared in the preparing process S1, with the groove portion 101a being provided at a position corresponding to the seam thereof The shaft portion 102 is rotatably supported by a rotating mechanism (omitted from illustration).

When forming the dome members 32, 33, the fiber bundle F1 is first wound onto the mandrel 100 so as to cover the outer face thereof, by rotating the mandrel 100. At this time, the cylindrical protruding portion 32b having a through hole 32c is formed by winding the fiber bundle F1 onto the outer face of the shaft portion 102 as well, as illustrated in FIG. 5. Also at this time, the fiber bundle F1 is wound at an angle intersecting the axial direction of the shaft portion 102 by 30 to 50 degrees, for example. Note that while the material of the mandrel 100 is not limited in particular, metal is preferable in order to secure strength so as to not be deformed when winding the fiber bundle F1.

Although the resin with which the fiber bundle F1 is impregnated is not limited in particular, a thermosetting resin may be used, for example. Preferable examples of thermosetting resin that can be used include phenolic resins, melamine resins, urea-formaldehyde, and epoxy resins. In this arrangement, the fiber bundle F1 is wound on the mandrel 100 in a state where the thermosetting resin is not yet set, and thereafter is heated. In particular, epoxy resins are preferably used from the perspective of mechanical strength and so forth. Epoxy resins have fluidity in an unset state, and once set, form a strong crosslinked structure.

Also note that thermoplastic resins may be used as the resin with which the fiber bundle F1 is impregnated. Examples of thermoplastic resins that can be used include polyether ether ketone, polyphenylene sulfide, polyacrylate ester, polyimide, and polyamide. In this arrangement, the fiber bundle F1 is wound on the mandrel 100 in a state where the thermoplastic resin is heated and softened, following which the thermoplastic resin is cooled and hardened. Note that in the present specification, both thermal setting of thermosetting resin and hardening of softened thermoplastic resin by cooling will be collectively referred to as hardening of resin.

Examples of fibers that can be used to constitute the fiber bundle F1 include glass fibers, aramid fibers, boron fibers, and carbon fibers. In particular, carbon fibers are preferably used from the perspective of lightness, mechanical strength, and so forth.

Next, the wound article (fiber bundle F1) wound on the outer face of the mandrel 100 is divided into two, using a cutter 110 (see FIG. 4). Thereafter, the divided wound article is separated from the mandrel 100, thereby yielding the two dome members 32, 33, as illustrated in FIG. 5.

Specifically, the neck 4 is attached to the outer face of the protruding portion 32b from the state illustrated in FIG. 4. In a state where the resin with which the fiber bundle F1 of the wound article has been impregnated is hardened, the blade tip of the cutter 110 is inserted into the groove portion 101a of the mandrel 100 while rotating the mandrel 100. Thus, the fiber bundle F1 can be cut by the cutter 110, and the wound article can be divided into two. Thereafter, in a state where the resin of the wound article (fiber bundle F1) remains hardened, the wound article is separated from the mandrel 100, thereby yielding the two dome members 32, 33. Note that the cutter 110 is not limited in particular, and examples thereof that can be used include arrangements where a blade is provided on a circumferential face of a rotating disc, arrangements where a blade is formed on a side face of a thin plate, and arrangements where the fiber bundle F1 is cut using a laser beam.

Cutting is performed by the cutter 110 in a state where the resin with which the fiber bundle F1 is impregnated is hardened. Therefore, deformation of the fiber bundle F1 when cutting can be suppressed, and deformation of the two dome members 32, 33 when removing from the mandrel 100 can be suppressed.

When the resin of the fiber bundle F1 (i.e., the two dome members 32, 33) is made of thermosetting resin, the method for hardening the fiber bundle F1 is not limited in particular, and the fiber bundle F1 is hardened under hardening conditions (heating temperature and heating time) corresponding to the type of resin. On the other hand, when the resin of the fiber bundle F1 is made of thermoplastic resin, the resin of the fiber bundle F1 is hardened by cooling the fiber bundle F1 from a state where the resin has fluidity, as for a method of hardening the fiber bundle F1. The dome members 32, 33 thus yielded are formed to shapes that cover the outer faces of the end portions 22, 23 of the liner 2, respectively.

Although an example has been given here of winding the fiber bundle F1 that is impregnated with resin on the outer face of the mandrel 100, an arrangement may be made where a fiber bundle that is not impregnated with resin is wound on the outer face of the mandrel 100 to form a wound article, which is then impregnated with resin and hardened.

Also, although an example has been given here of cutting the fiber bundle F1 using a cutter 110 in a state where the resin is hardened, the fiber bundle F1 may be cut by the cutter 110 without hardening the resin of the fiber bundle F1. In this arrangement, the fiber bundle F1 may be hardened after cutting by the cutter 110.

Note however, that when the resin of the fiber bundle F1 is not hardened, the resin has viscosity and the fiber bundle F1 is not readily removed from the mandrel 100 (the fiber bundle F1 is easily deformed). Accordingly, deformation of the fiber bundle F1 is preferably suppressed by, for example, coating the surface of the mandrel 100 with a mold release agent prior to winding the fiber bundle F1, or reducing the speed of releasing the two dome members 32, 33 from the mandrel 100.

Also, although an example has been described here where the neck 4 is attached to the outer face of the protruding portion 32b after winding the fiber bundle F1 on the outer face of the mandrel 100, an arrangement may be made where the neck is attached to a connecting portion between the main unit 101 and the shaft portion 102 of the mandrel 100 in advance, and part of the neck is wound with the fiber bundle F1 along with the outer face of the mandrel 100 in this state. Part of the neck is covered by the fiber bundle F1 and is constrained in this arrangement, whereby the neck can be strongly fixed by the fiber bundle F1.

### Method of Forming Cylindrical Member 31

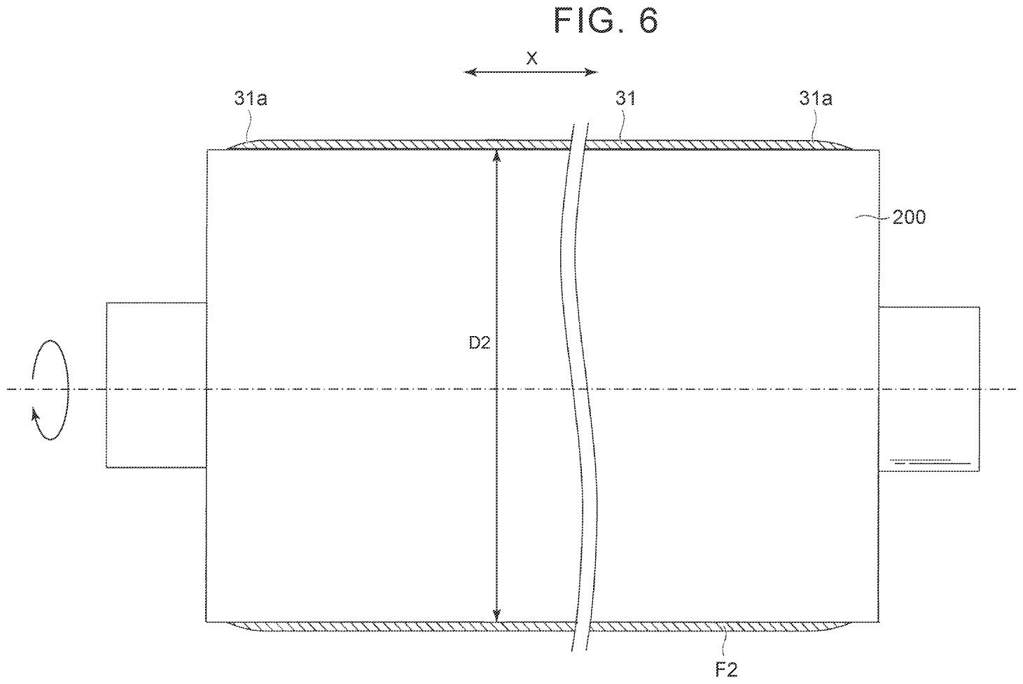

The cylindrical member 31 is formed by winding a fiber sheet F2 onto an outer face of a cylindrical mandrel 200, for example, as illustrated in FIG. 6. The outside diameter of the mandrel 200 is an outside diameter that corresponds to the inside diameter D2 of the cylindrical member 31. While the material of the mandrel 200 is not limited in particular, metal is preferable in order to secure strength so as not to be deformed when applying the fiber sheet F2.

When forming the cylindrical member 31, the fiber sheet F2 that is rolled out from a roll, etc. is wound on the mandrel 200 a plurality of times while rotating the mandrel 200 in the circumferential direction by a rotating mechanism (omitted from illustration). The fiber sheet F2 is a sheet of reinforcing fibers drawn in one direction and impregnated with resin. The fiber sheet F2 is wound on the mandrel 200 with the reinforcing fibers oriented following the circumferential direction of the mandrel 200. Accordingly, the reinforcing fibers are oriented following the circumferential direction, and the cylindrical member 31 having the inside diameter D2 is formed.

Although a so-called unidirectional (UD) sheet where a plurality of fiber bundles oriented in the same direction are woven in by binding strands, for example, is used for the fiber sheet F2, a fiber sheet may be used where a plurality of fiber bundles oriented in the same direction, and a plurality of fiber bundles intersecting the plurality of fiber bundles, orthogonally for example, are woven, or the like.

Note that examples of the reinforcing fibers for the fiber sheet F2 may be the same as the materials exemplified regarding the fiber bundle F1, and examples of the resin with which the reinforcing fibers are impregnated may be the same as the materials exemplified regarding the fiber bundle F1.

The cylindrical member 31 is formed with the thicknesses of the circumferential edge portions 31a in the axial direction X becoming gradually smaller toward the ends, as illustrated in FIG. 6. According to this shape, when the circumferential edge portions 31a of the cylindrical member 31 and the circumferential edge portions 32a, 33a of the dome members 32, 33 are placed upon each other as illustrated in FIGS. 1 and 2, a stepped portion is less readily formed at the connecting portions of the outer face of the cylindrical member 31 and the outer faces of the two dome members 32, 33.

In order to make the thicknesses at both ends of the cylindrical member 31 in the axial direction X smaller, the fiber bundles may be woven such that the thickness of fiber bundles at the end portion of the fiber sheet F2 in the axial direction X (width direction) gradually becomes smaller, or the winding width of the fiber sheet F2 may be gradually reduced. Alternatively, the thicknesses of both ends of the cylindrical member 31 in the axial direction X may be gradually made smaller by being pressed by a roller or the like. Note that the thicknesses of the circumferential edge portions 32a, 33a of the dome members 32, 33 may also be made smaller in comparison with other portions by being pressed by a roller or the like.

When the resin of the fiber sheet F2 is made of thermosetting resin, the fiber sheet F2 may be hardened under predetermined hardening conditions (heating temperature and heating time), in a state where the fiber sheet F2 is wound on the mandrel 200, in the same way as with the fiber bundle F1. On the other hand, when the resin of the fiber sheet F2 is made of thermoplastic resin, the resin of the fiber sheet F2 may be hardened by cooling in a state where the fiber sheet F2 is wound on the mandrel 200, in the same way as with the fiber bundle F1.

After hardening of the resin, the cylindrical member 31 is removed from the mandrel 200. Hardening the resin improves the shape retention of the cylindrical member 31. The cylindrical member 31 can accordingly be easily released from the mandrel 200, and deformation of the cylindrical member 31 at the time of removing the cylindrical member 31 from the mandrel 200 can be suppressed.

Note that an example has been described here where the fiber sheet F2 is wrapped onto the outer face of the mandrel 200 to form the cylindrical member 31. However, the cylindrical member 31 may be formed by hoop winding of fiber bundles impregnated with resin on the outer face of the mandrel 200 by the FW procedure. Alternatively, as another method, the cylindrical member 31 may be formed using a so-called centrifugal winding (CW) method, where fiber sheets are applied to the inner face of the mandrel 200 that is rotating.

### Method of Forming Liner 2

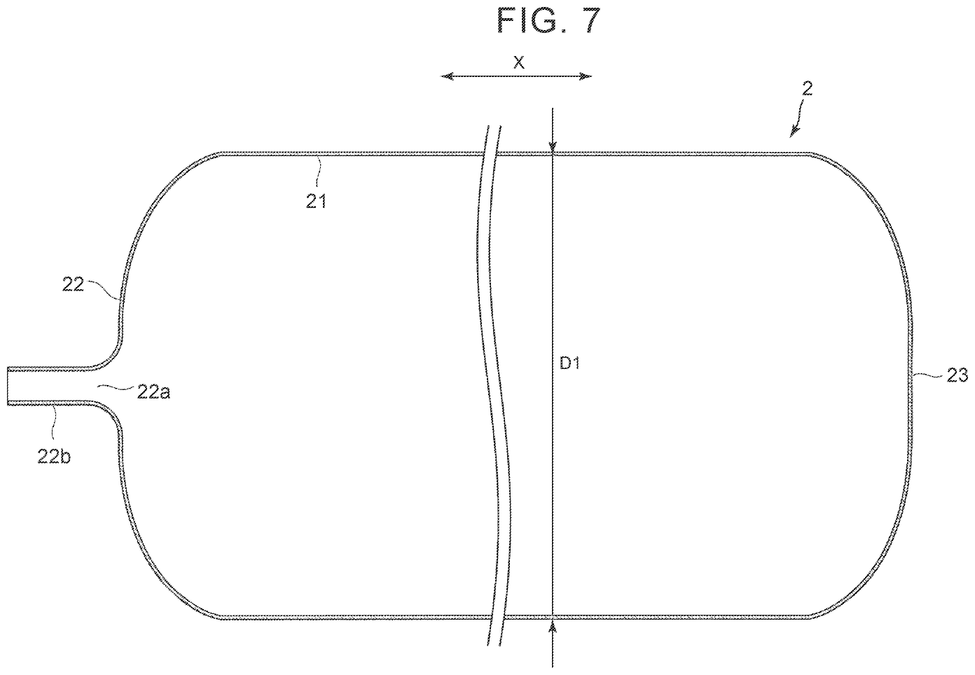

The liner 2 is formed with the outside diameter D1 of the body 21 of the liner 2 being larger than the inside diameter D2 of the cylindrical member 31, as illustrated in FIG. 7. Specifically, a body member (omitted from illustration) corresponding to the body 21 and two end members (omitted from illustration) corresponding to the end portions 22, 23 are prepared. The opening 22a is formed at the apex of the dome-shaped end member corresponding to the end portion 22, and the tubular portion 22b is formed in the opening 22a.

Next, the end members are joined to respective ends of the body member that has been prepared, by welding, thermal fusing, or the like. Thus, the liner 2 having the cylindrical body 21 and the dome-shaped end portions 22, 23 formed continuously on respective ends of the body 21 can be formed, as illustrated in FIG. 7.

In the present embodiment, the liner 2 is fit to the cylindrical member 31 here using shrink fitting by cooling (compression shrink fitting) in the later-described fitting process. Accordingly, in the state prior to cooling, the outside diameter D1 of the body 21 is larger than the inside diameter D2 of the cylindrical member 31 under the same temperature (specifically, at room temperature) conditions. This state prior to cooling is a state where the inside of the liner 2 is opened eternally at the ambient temperature (specifically, at room temperature) of the liner 2.

Further, in the present embodiment, the material of the body member and the two end members (i.e., the material of the liner 2) is made of resin or metal, as described above. These materials are materials that have shrinking properties at low temperatures, and in particular, out of various types of resin, thermoplastic resin is a material that exhibits higher shrinking properties at low temperatures as compared to the fiber reinforced resin making up the cylindrical member 31. Accordingly, the liner 2 that is cooled to a lower temperature (e.g., a temperature lower than ordinary temperature) can be shrunk (thermal contraction) such that the reduced outside diameter D1 can be smaller than the inside diameter D2 of the cylindrical member 31.

### 2-2. Shrinking Process S2

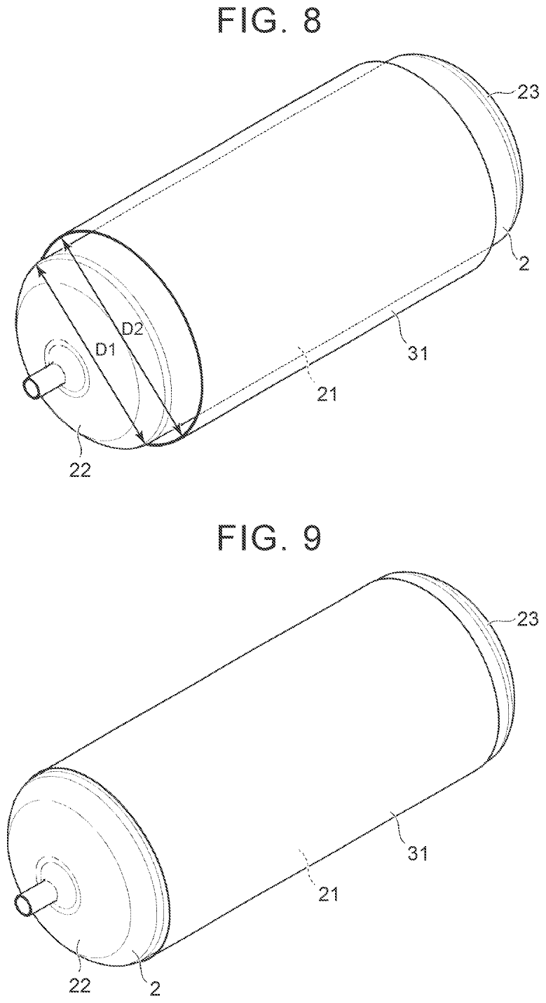

In the shrinking process S2, the liner 2 is shrunk by cooling the liner 2. Specifically, in the shrinking process S2, the liner 2 is cooled to a temperature where the outside diameter D1 of the body 21 of the liner 2 is smaller than the inside diameter D2 of the cylindrical member 31 (specifically, a temperature lower than room temperature), as illustrated in FIG. 8.

The cooling method is not limited in particular, as long as the liner 2 can be cooled. For example, the liner 2 may be cooled by storing the liner 2 in a freezing chamber or refrigeration chamber or the like, wind cooler than room temperature may be blown on the surface of the liner 2 so as to be cooled, or the liner 2 may be cooled by being brought into contact with a substance cooler than room temperature (water, dry ice, etc.). Alternatively, the accommodation space 5 may be filled with a refrigerant that is cooler than room temperature, from the tubular portion 22b and the opening 22a of the liner 2, and thus be cooled.

Note that the cooling temperature of the liner 2 is not limited in particular as long as the temperature is lower than the temperature of the cylindrical member 31 and the outside diameter D1 of the body 21 of the liner 2 is smaller than the inside diameter D2 of the cylindrical member 31. For example, the cooling temperature is in a range of around −30° C. to 10° C., and the liner 2 is preferably cooled within a temperature range where the material of the liner 2 does not exhibit low temperature brittleness.

### 2-3. Inserting Process S3

In the inserting process S3, the liner 2 is inserted into the cylindrical member 31 such that the cylindrical member 31 covers the body 21 of the liner 2 in the shrunk state in the shrinking process S2, as illustrated in FIG. 8. The liner 2 is shrunk in the shrinking process S2 such that the outside diameter D1 of the body 21 of the liner 2 is smaller than the inside diameter D2 of the cylindrical member 31, and accordingly the liner 2 can be easily inserted into the cylindrical member 31.

### 2-4. Fitting Process S4

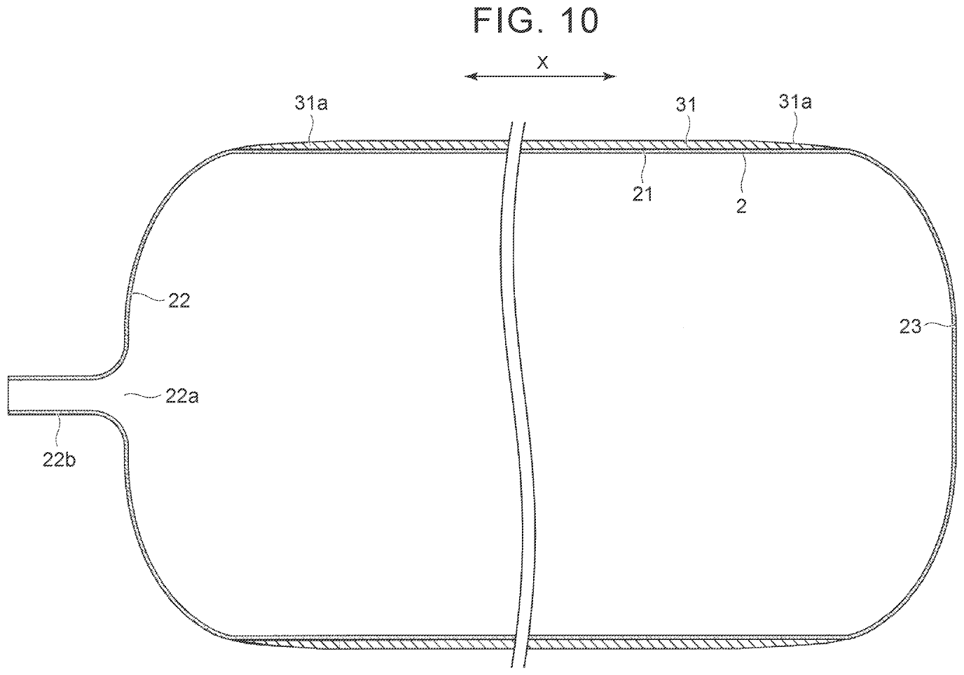

In the fitting process S4, the temperature of the liner 2 inserted into the cylindrical member 31 is returned to the temperature prior to cooling in the shrinking process S2, thereby expanding the shrunken liner 2 and fitting the cylindrical member 31 to the body 21, as illustrated in FIGS. 9 and 10.

Now, the “temperature prior to cooling” is a temperature that satisfies the dimensional relation where the outside diameter D1 of the body 21 of the liner 2 is larger than the inside diameter D2 of the cylindrical member 31. Accordingly, the rise in temperature of the liner 2 causes the liner 2 to expand, and this expansion occurs in the radial direction of the liner 2 as well, whereby the cylindrical member 31 can be fit to the body 21 of the liner 2. Thus, the cylindrical member 31 can be integrated with the body 21 of the liner 2.

The temperature of the liner 2 may be raised using a heating device or the like, but in the present embodiment, the temperature of the liner 2 is gradually raised to the ambient temperature (room temperature) immediately prior to cooling. That is to say, the cooled liner 2 is left standing under so-called ordinary temperature and normal pressure conditions. The ordinary temperature and normal pressure conditions here are, for example, a temperature range of 15° C. to 25° C. for ordinary temperature, and atmospheric pressure for normal pressure. By raising the temperature in this way, the liner 2 can be fit to the cylindrical member 31 with the outer face of the body 21 of the liner 2 following the inner face of the cylindrical member 31, while suppressing thermal shock to the liner 2 due to the rise in temperature.

Further, the body 21 of the liner 2 and the cylindrical member 31 are cylindrical in the present embodiment, and accordingly when the temperature of the liner 2 rises to the temperature prior to cooling of the liner 2 in the fitting process, the outer circumferential face of the liner 2 can be made to uniformly follow the inner circumferential face of the cylindrical member 31. Thus, formation of a gap between the body 21 of the liner 2 and the cylindrical member 31 can be made to occur less readily.

Now, returning to the preparing process S1, the relation between the body 21 of the liner 2 and the cylindrical member 31 will be described in detail. For the outside diameter D1 of the body 21 of the liner 2 and the inside diameter D2 of the cylindrical member 31 in the preparing process S1, (1) outside diameter D1<inside diameter D2 is satisfied at the cooling temperature in the shrinking process S2, and (2) outside diameter D1>inside diameter D2 is satisfied at the temperature after expansion in the fitting process S4 (specifically, the temperature in the preparing process S1). The body 21 of the liner 2 can be fit to the cylindrical member 31 by both of the (1) and (2) above.

Additionally, the outside diameter D1 of the body 21 and the inside diameter D2 of the cylindrical member 31 are preferably set such that after the rise in temperature of the liner 2 is completed, the pressure of the cylindrical member 31 pressing against the body 21 of the liner 2 is smaller than the yield stress of the material of the liner 2.

According to such settings, the expansive force of the liner 2 is calculated by E×α×dT, where E represents the Young's modulus of the material of the liner 2, a represents the linear thermal expansion coefficient of the material, and dT represents the temperature change from the cooled state until expansion is complete. The pressure of the cylindrical member 31 pressing against the body 21 of the liner 2 can be calculated by normal mechanics of materials calculations and so forth, taking the outside diameter D1 of the body 21 of the liner 2 prior to cooling and the inside diameter D2 of the cylindrical member 31 into consideration along with this expansive force.

By performing settings in this way, the pressure of the cylindrical member 31 pressing against the body 21 of the liner 2 is smaller than the yield stress of the material of the liner 2, and accordingly the liner 2 can be fit into the cylindrical member 31 in a state where the liner 2 is elastically deformed. Accordingly, the liner 2 is not damaged due to plastic deformation in the fitting process S4.

As described above, the first reinforcing layer 30 is formed on the outer face of the liner 2 in the present embodiment, rather than wrapping fiber reinforced resin sheets or fiber bundles or the like on the body 21 of the liner 2. Thus, only deformation taking into consideration the tightening margin between the body 21 of the liner 2 and the cylindrical member 31 (calculated in advance) is generated in the liner 2 by the fitting process S4, and accordingly unexpected deformation of the liner 2 due to force of overtightening and so forth can be avoided.

Note that when the liner 2 is made of a thermoplastic resin, cracks and the like do not readily occur in the liner 2 even when there is plastic deformation of the liner 2 in the fitting process S4, since thermoplastic resins materials are more ductile than metal.

### 2-5. Joining Process S5

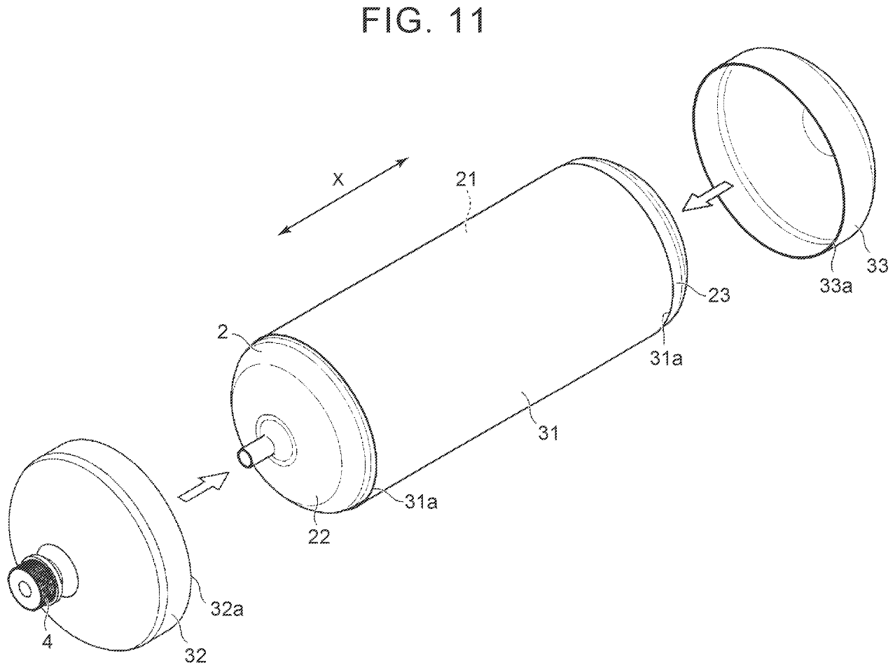

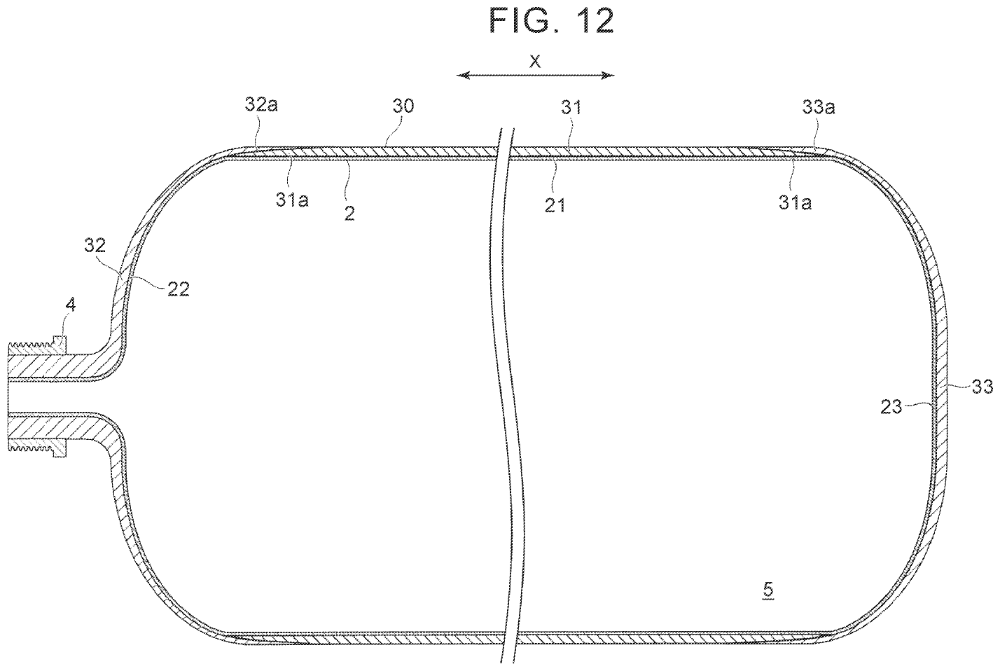

In the joining process S5, the circumferential edge portions 32a, 33a of the dome members 32, 33 are joined to the circumferential edge portions 31a of the cylindrical member 31 to which the body 21 is fit such that the dome members 32, 33 cover the end portions 22, 23 of the liner 2, as illustrated in FIGS. 11 and 12, thereby forming the first reinforcing layer 30.

Specifically, the circumferential edge portions 31a of the cylindrical member 31 and the circumferential edge portions 32a, 33a of the dome members 32, 33 are fit together, with one on the inner side and the other on the outer side. Thus, the cylindrical member 31 and the dome members 32, 33 can be joined more strongly. FIG. 12 illustrates an example of this fitting, where the circumferential edge portions 31a of the cylindrical member 31 are on the inner side and the circumferential edge portions 32a, 33a of the dome members 32, 33 are on the outer side, as one example. The cylindrical member 31 is integrated with the body 21 of the liner in the fitting process S4 in the present embodiment. Accordingly, the circumferential edge portions 32a, 33a of the dome members 32, 33 can be easily joined to the circumferential edge portions 31a of the cylindrical member 31, and the first reinforcing layer 30 composed of the cylindrical member 31 and the two dome members 32, 33 can be easily formed on the outer face of the liner 2.

When fitting the cylindrical member 31 and the dome members 32, 33 together, an adhesive agent may be disposed on the fitting faces of the cylindrical member 31 and the dome members 32, 33. According to this configuration, the cylindrical member 31 and the dome members 32, 33 can be suppressed from coming apart in a later process in an even more reliable manner. The material of the adhesive agent is not restricted in particular, but using a thermosetting resin such as epoxy resin or the like, for example, is preferable. Also, resin of the same component as that of the cylindrical member 31 or the dome members 32, 33 may be used as the adhesive agent.

Although an example of fitting the circumferential edge portions 31a of the cylindrical member 31 and the circumferential edge portions 32a, 33a of the dome members 32, 33 to each other has been described here, an arrangement may be made where the circumferential edge portions 31a of the cylindrical member 31 and the circumferential edge portions 32a, 33a of the dome members 32, 33 are abutted against each other, and joined by an adhesive agent.

### 2-6. Second Reinforcing Layer Forming Process S6

In the second reinforcing layer forming process S6, the second reinforcing layer 34 made of fiber reinforced resin is formed so as to cover the outer face of the first reinforcing layer 30, as illustrated in FIG. 1. Thus, the reinforcing portion 3 having the first reinforcing layer 30 and the second reinforcing layer 34 can be formed.

When forming the second reinforcing layer 34, a fiber bundle impregnated with resin is wound in layers by helical winding on the surface of the first reinforcing layer 30 by the FW procedure. Helical winding is a way of winding where winding over the dome members 32, 33 proceeds obliquely (in a range of no less than 10° and no more than 60°) as to the axial direction X of the cylindrical member 31. The number of layers of the fiber bundle being wound is not limited in particular, as long as the strength of the second reinforcing layer 34 is ensured, but is around two to ten layers, for example.

Note that examples of the material of the reinforcing fibers for the fiber bundle may be the same as the materials exemplified regarding the fiber bundle F1, and examples of the resin with which the reinforcing fibers are impregnated may be the same as the resin materials exemplified regarding the fiber bundle F1.

After ending winding of the fiber bundle on the outer face of the first reinforcing layer 30, the second reinforcing layer 34 is thermally set when the resin with which the fiber bundle is impregnated is a thermosetting resin. The second reinforcing layer 34 is hardened by cooling when the resin with which the fiber bundle is impregnated is a thermoplastic resin, either by cooling in still air or by forced cooling. After forming the second reinforcing layer 34 in this way, the valve 6 is attached to the neck 4, thereby completing the high pressure tank 1, as illustrated in FIG. 1.

According to the present embodiment, a fiber reinforced resin sheet or the like is not wound onto the body 21 of the liner 2 when forming the first reinforcing layer 30 on the outer face of the liner 2, whereby unexpected deformation of the liner 2 due to overtightening at the time of winding can be avoided.

The embodiment disclosed here should be understood to be exemplary in all points, and not restrictive. The scope of the disclosure is not laid forth in the above-described embodiment but in the claims, and is intended to include all equivalencies of the claims and all modifications that may be made without departing from the scope thereof

For example, the shape of the body of the liner has been described as being cylindrical, and the shape of the cylindrical member as being cylindrical as well, in the present embodiment. However, the shape is not limited in particular as long as the cylindrical member can be fit to the body of the liner, and may be a flattened shape (elliptical shape) thereof, a polygonal shape, or the like.

Also, for example, an example of forming the two dome members using the FW procedure has been described in the present embodiment, but the disclosure is not limited to this. For example, the two dome members may be formed by applying fiber bundles to the surface of dome-shaped molds under pressure by a roller, using a tape placement process.

Also, although an example of forming the first reinforcing layer from three members (cylindrical member and dome members) has been described in the present embodiment, the disclosure is not limited to this. For example, the first reinforcing layer may be formed from four or more members (two or more cylindrical members, and dome members). In this arrangement, the two or more cylindrical members may be joined to each other, and thereafter the dome members be joined to the ends thereof Alternatively, one each of a dome member and a cylindrical member may be joined to each other, and thereafter these be joined together.

What is claimed is:

1. A manufacturing method of a high pressure tank, where a reinforcing layer made of fiber reinforced resin is formed on an outer face of a liner that includes a body having a cylindrical shape and end portions having a domical shape and formed on respective ends of the body, the method comprising:
preparing the liner, and a cylindrical member and two dome members that constitute the reinforcing layer;
shrinking the liner by cooling the liner;
inserting the liner into the cylindrical member to cover the body of the liner in a shrunk state by the cylindrical member;
expanding the liner in the shrunk state to fit the cylindrical member to the body by raising a temperature of the liner inserted into the cylindrical member to a temperature prior to the cooling of the liner; and
joining circumferential edge portions of the dome members to circumferential edge portions of the cylindrical member that is fit to the body, to cover the end portions of the liner by the dome members, and form the reinforcing layer.

2. The manufacturing method according to claim 1, wherein:
the cylindrical member is cylindrical;
in the preparing of the liner and the cylindrical member and the two dome members, the liner and the cylindrical member are prepared satisfying a dimensional relation where an outside diameter of the body of the liner is larger than an inside diameter of the cylindrical member;
in the shrinking of the liner, the liner is cooled to a temperature where the outside diameter of the body of the liner is smaller than the inside diameter of the cylindrical member; and
in the fitting of the cylindrical member to the body, the temperature of the liner is raised to the temperature prior to the cooling of the liner, where the dimensional relation is satisfied.

3. The manufacturing method according to claim 2, wherein in the preparing of the liner and the cylindrical member and the two dome members, the outside diameter of the body and the inside diameter of the cylindrical member are set such that a pressure of the cylindrical member pressing against the body of the liner after completion of raising the temperature of the liner is smaller than a yield stress of a material of the liner.

4. The manufacturing method according to claim 1, wherein the liner is made of thermoplastic resin.
